(19) United States
(12) Patent Application Publication
(10) Pub. No.: US 2026/0316226 A1
(43) Pub. Date: Oct. 15, 2026

(54) ADAPTER SOCKET STRUCTURE

(71) Applicant: PALOS ENTERPRISE CO., LTD., Taichung City (TW)

(72) Inventor: Hsien-Liang CHEN, Taichung City (TW)

(21) Appl. No.: 19/178,883

(22) Filed: Apr. 15, 2025

(51) Int. Cl. B25B 13/06

(52) U.S. Cl. CPC B25B 13/06

(57) ABSTRACT

An adapter socket structure includes a socket body having a driving portion that is formed with a driving hole and an acting portion coaxially connected to the driving portion and formed with an acting hole. The outside diameter of the driving portion is greater than that of the acting portion, so as to form a stepped portion between outer circumferential surfaces thereof. A protective tube is made of a composite material and sleeved on the acting portion to be rotatable relative to the socket. One end of the protective tube is supported on the stepped portion. An anti-detachment ring is sleeved on the acting portion and includes a second connecting portion engageable with the first connecting portion. An opposite end of the protective tube is supported o the anti-detachment ring.

### BACKGROUND OF THE INVENTION

### (a) Technical Field of the Invention

The present invention relates generally to accessories of pneumatic tools, and more particularly to an adapter socket structure.

### (b) Description of the Prior Art

To install a wheel rim to a car or to remove a wheel rim from a car, a pneumatic tool is usually used as a power source to tighten or loosen nuts through connection to corresponding sockets.

However, the sockets that commonly connect to pneumatic tools are made of metal because they need to have a certain degree of rigidity to prevent deformation. When the socket is tightening or loosening a nut, or during a process performed before and after the operation, it is very easy for the socket to collide with the wheel rim, resulting in scratches on the wheel rim. This situation is very difficult to accept for car owners with high requirements or car owners who have expensive wheel rims (aluminum alloy rims), resulting in disputes between car repair shops (tire shops) and the car owners.

For example, Taiwan Patent No. I702116 discloses a known socket, which mainly comprises a socket body and a tubular member. The socket body has a socket head and a socket trunk. The outer diameter of the socket head is larger than the outer diameter of the socket trunk, so that a shoulder is formed at the junction between the socket head and the socket trunk. The shoulder is formed with an engagement groove. The tubular member is made of composite material and is sleeved on the socket trunk of the socket body. One end of the tubular member has an engagement portion, and the engagement portion engages with the engagement groove of the socket body to position the tubular member and the socket body, so that the tubular member and the socket body cannot rotate relative to each other. Although, in such a known structure of socket, the tubular member can be used to improve recognizability, that is, texts, numerals, or patterns for identifying the size can be printed on the tubular member. However, the tubular member and the socket body are combed together through inter-engagement between the engagement portion and the engagement groove, the tubular member and the socket body are not allowed to rotate relative to each other (that is, the two rotate synchronously). Therefore, once the socket body is driven by a pneumatic tool to rotate, the tubular member will also be forced to rotate, so that the tubular member, once accidentally contacting the wheel rim, may generate rolling abrasion on the wheel rim, causing damage to the wheel rim.

### SUMMARY OF THE INVENTION

In view of the above, it is desired to improve the prior art in order to overcome the problem that the conventional socket may easily scratch and thus damage a wheel rim. Thus, the present invention provides an adapter socket structure, which comprises: a socket body, which comprises a driving portion and an acting portion coaxially connected to the driving portion, a driving hole being formed in a free end face of the driving portion by recessing inward in an axial direction, an acting hole being formed in a free end face of the acting portion by recessing inward in an axial direction, an outside diameter of the driving portion being greater than an outside diameter of the acting portion, so that a stepped portion is formed at intersection between outer circumferential surfaces of the driving portion and the acting portion, the acting portion being formed with a first connecting portion on the outer circumferential surface; a protective tube, which is integrally formed of a composite material and is sleeved on the outer circumferential surface of the acting portion of the socket body, the protective tube being rotatable relative to the socket body, one end of the protective tube being supported on the stepped portion; and an anti-detachment ring, an inner circumferential surface of the anti-detachment ring being formed with a second connecting portion, the anti-detachment ring being sleeved on the outer circumferential surface of the acting portion of the socket body, the second connecting portion being in engagement with the first connecting portion, an opposite end of the protective tube abutting the anti-detachment ring. As such, abrasion and damage to a wheel rim can be reduced.

### BRIEF DESCRIPTION OF THE DRAWINGS

FIG. 1 is a perspective view showing a first preferred embodiment of the present invention in a disassembled form.

FIG. 2 is a perspective view showing the embodiment illustrated in FIG. 1 in an assembled form.

FIG. 3 is a cross-sectional view showing the embodiment illustrated in FIG. 1 in an assembled form.

FIG. 4 is a perspective view showing a second preferred embodiment of the present invention in a disassembled form.

FIG. 5 is a perspective view showing the embodiment illustrated in FIG. 4 in an assembled form.

FIG. 6 is a cross-sectional view showing the embodiment illustrated in FIG. 1 in an assembled form.

### DETAILED DESCRIPTION OF THE PREFERRED EMBODIMENTS

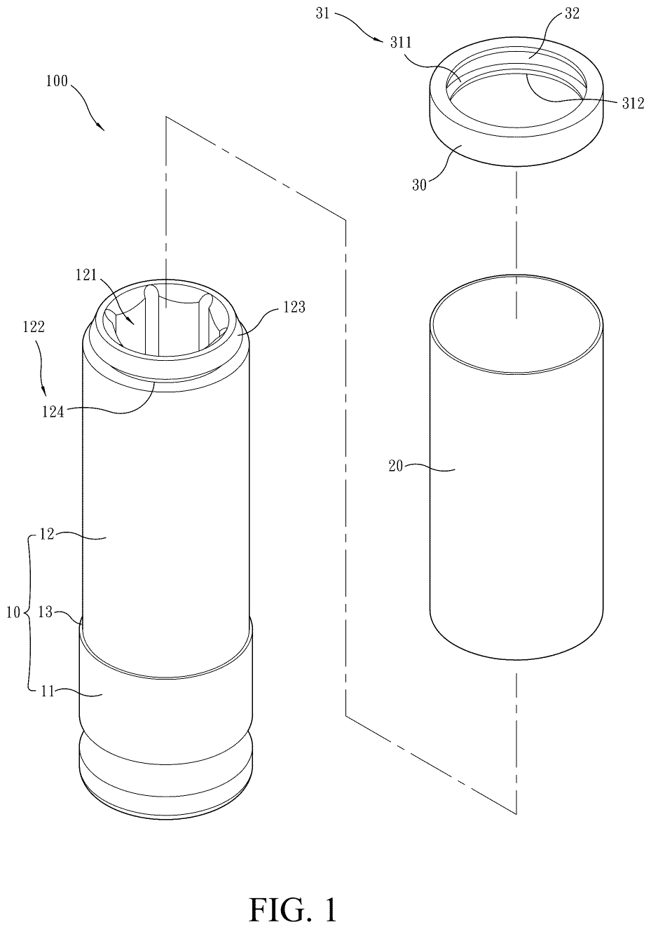

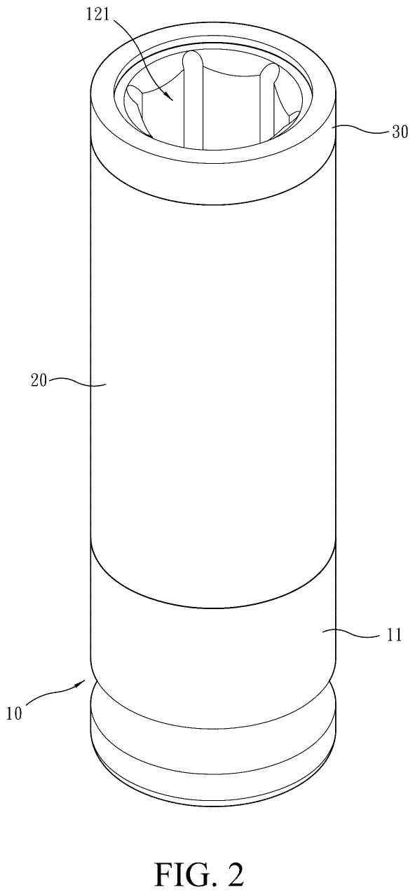

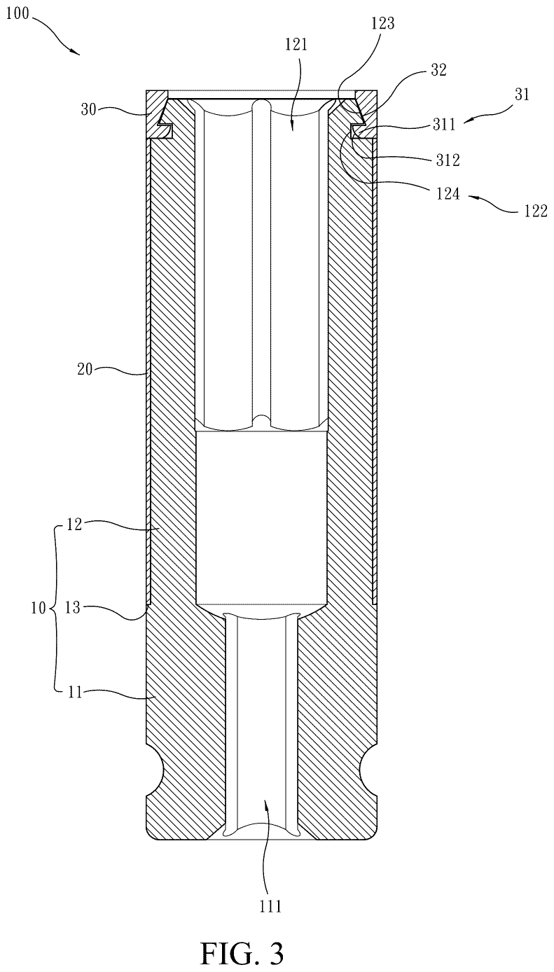

Referring to FIGS. 1-3, an adapter socket structure 100 according to a first preferred embodiment of the present invention mainly comprises a socket body 10, a protective tube 20, and an anti-detachment ring 30.

Referring to FIGS. 1-3, the socket body 10 is a cylindrical body made of metal material. The socket body 10 comprises a driving portion 11 and an acting portion 12 integrally and coaxially connected to the driving portion 11. An outside diameter of the driving portion 11 is greater than an outside diameter of the acting portion 12, so that a stepped portion 13 is formed at the intersection between outer circumferential surfaces of the driving portion 11 and the acting portion 12. A driving hole 111 is formed in a free end face of the driving portion 11 by recessing inward from a center axis position thereof in an axial direction. In the instant embodiment, the driving hole 111 is a tetragonal hole. An acting hole 121 is formed in a free end face of the acting portion 12 by recessing inward from a center axis position thereof in an axial direction. In the instant embodiment, the acting hole 121 is a hexagonal hole. The acting portion 12 is formed with a first connecting portion 122 on the outer circumferential surface thereof adjacent to the free end thereof. The first connecting portion 122 can be an annular groove 124. A first slope 123 is formed on the outer circumferential surface of the acting portion 12 between the free end thereof and the first connecting portion 122.

Referring to FIGS. 1-3, the protective tube 20 is an axial hollow tube integrally formed of a composite material (such as carbon fiber or glass fiber based composite materials). A length of the protective tube 20 is shorter than a length of the acting portion 12 of the socket body 10. The protective tube 20 is sleeved on the outer circumferential surface of the acting portion 12 of the socket body 10, with one end thereof supported on the stepped portion 13, such that an outer circumferential surface of the protective tube 20 is flush with the outer circumferential surface of the driving portion 11. However, the first connecting portion 122 of the socket body 10 is not covered by the protective tube 20. A gap is present between an inner circumferential surface of the protective tube 20 and the outer circumferential surface of the acting portion 12, so that the protective tube 20 and the socket body 10 are rotatable relative to each other. In other words, when the socket body 10 is acted upon by an external force to rotate, the protective tube 20 does not rotate therewith. A thickness of a tubular wall of the protective tube 20 is between 0.3 mm-0.8 mm.

Referring to FIGS. 1-3, the anti-detachment ring 30 is an annular body integrally formed of plastic or silicone material. An inner circumferential surface of the anti-detachment ring 30 is formed with a second connecting portion 31. The second connecting portion 31 can be a protruding ring 311. The protruding ring 311 comprises a slanted guide surface 312. A second slope 32 is formed on the inner circumferential surface of the anti-detachment ring 30 between one end thereof and the protruding ring 311. The anti-detachment ring 30 is sleeved on outside of the acting portion 12 of the socket body 10, and the protruding ring 311 of the second connecting portion 31 and the annular groove 124 of the first connecting portion 122 are engageable with and combined with each other so as to have the anti-detachment ring 30 fixed on the socket body 10, and one end of the anti-detachment ring 30 abuts another end of the protective tube 20 such that the protective tube 20 is constrained by the anti-detachment ring 30 and the stepped portion 13 to prevent detachment thereof. The second slope 32 of the anti-detachment ring 30 is in contact engagement with the first slope 123 of the socket body 10. The slanted guide surface 312 of the protruding ring 311 helps increase smoothness of the anti-detachment ring 30 fitting over the socket body 10 (that is reducing the frictional resistance during fitting). An outer circumferential surface of the anti-detachment ring 30 is flush with the outer circumferential surface of the protective tube 20.

Thus, the above provides an introduction to the components of the adapter socket structure 100 according to the first preferred embodiment of the present invention and the way of assembling thereof, and then, characteristics of will be described as follows:

Firstly, as the hardness of the protective tube 20 is lower than that of the socket body 10, and the protective tube 20 is rotatable relative to the socket body 10, when the present invention is connected to a pneumatic tool and reaches into a wheel rim to apply a rotational force to a nut, if the protective tube 20 accidentally contacts the wheel rim, the protective tube 20 will immediately stop rotating (that is, although the socket body is in rotation, the protective tube does not rotate), so as to avoid damage of the wheel rim caused by rolling wear.

Secondly, as the protective tube 20, when sleeved on the socket body 10, is not fixed to the socket body 10 and is instead rotatable relative thereto, assembling and disassembling can be implemented conveniently, so as to facilitate replacement of consumable parts, such as he protective tube 20 and the anti-detachment ring 30.

Further, in the above-described embodiment, the driving hole is a tetragonal hole and the acting hole is a hexagonal hole, but, in actual application, the driving hole and the acting hole can each be one of a tetragonal hole, a hexagonal hole, an octagonal hole, a dodecagonal hole, or a six-pointed star-shaped hole.

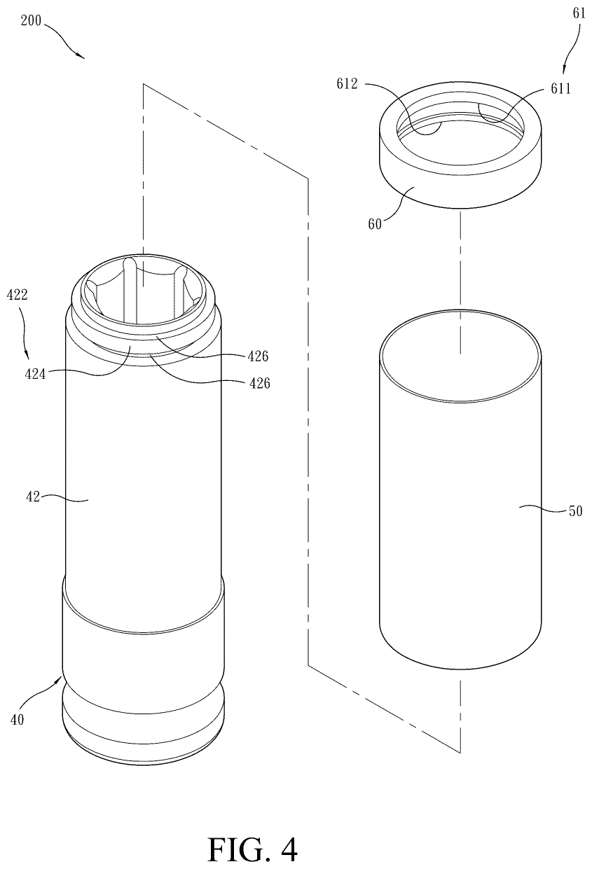

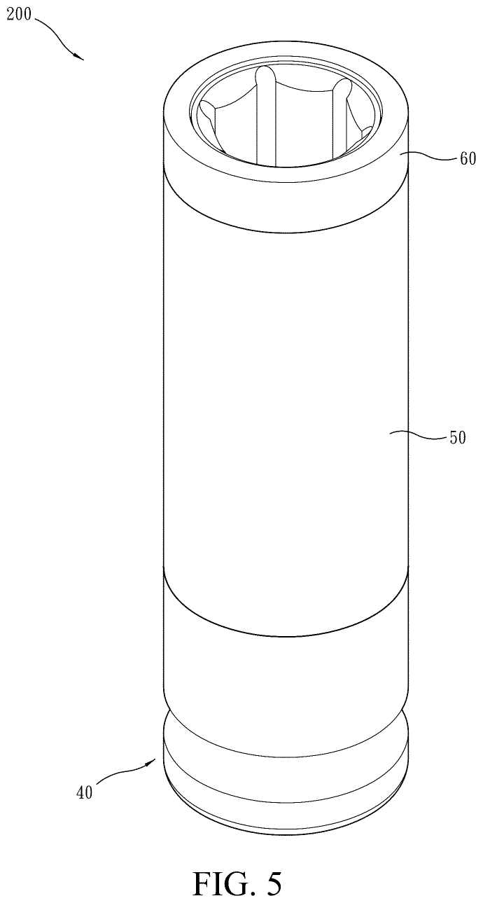

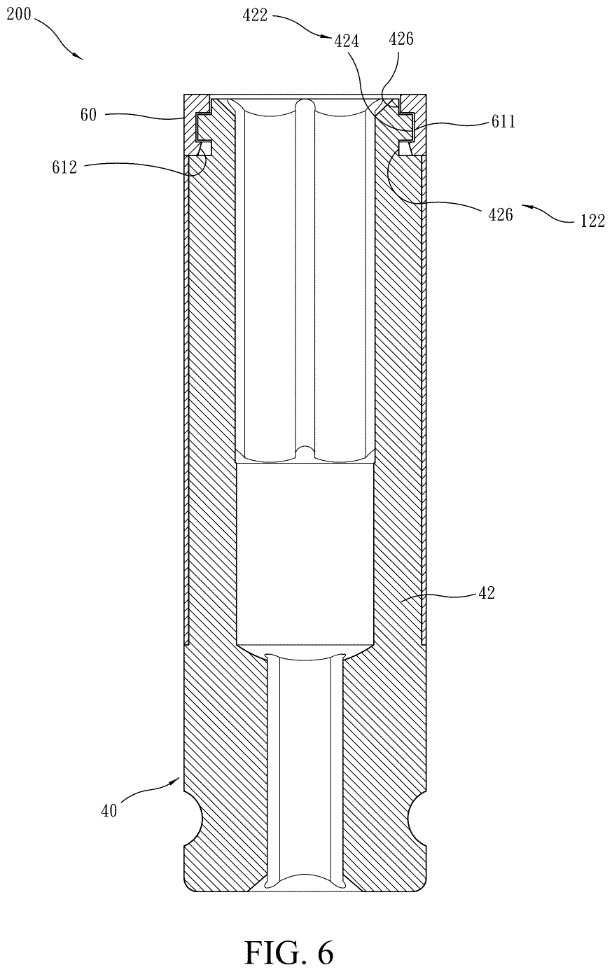

Referring to FIGS. 4-6, an adapter socket structure 200 according to a second preferred embodiment of the present invention, similar to the first embodiment, comprises a socket body 40, a protective tube 50, and an anti-detachment ring 60, and a main difference of the instant embodiment from the first embodiment is as follows:

In the instant embodiment, the socket body 40 comprises a first connecting portion 422 that is made in form of a protruding ring 424. That is an outer circumferential surface of an acting portion 42 of the socket body 40 is formed, in a junction thereof with each of two ends of the first connecting portion 422, with an annular furrow 426, and the two annular furrows 426 are spaced by a distance so that, at a location between the two annular furrow 426, the protruding ring 424 of the first connecting portion 422 is naturally formed.

The anti-detachment ring 60 comprises a second connecting portion 61, which in the instant embodiment is an annular groove 611. The anti-detachment ring 60 is formed with a slanted guide surface 612 on an inner circumferential surface thereof between one end thereof and the second connecting portion 61.

Thus, the annular groove 611 of the second connecting portion 61 of the anti-detachment ring 60 receives the protruding ring 424 of the first connecting portion 422 of the socket body 40 to insert therein and engage therewith to complete combination of the anti-detachment ring 60 with the socket body 40. The slanted guide surface 612 can similarly achieve reduction of frictional resistance during sleeving.

Although the structure of the instant embodiment is slightly different from that of the first embodiment, they can both achieve the same effect.

I claim:

1. An adapter socket structure, comprising:
a socket body, which comprises a driving portion and an acting portion coaxially connected to the driving portion, a driving hole being formed in a free end face of the driving portion by recessing inward in an axial direction, an acting hole being formed in a free end face of the acting portion by recessing inward in an axial direction, an outside diameter of the driving portion being greater than an outside diameter of the acting portion, so that a stepped portion is formed at intersection between outer circumferential surfaces of the driving portion and the acting portion, the acting portion being formed with a first connecting portion on the outer circumferential surface;
a protective tube, which is integrally formed of a composite material and is sleeved on the outer circumferential surface of the acting portion of the socket body, the protective tube being rotatable relative to the socket body, one end of the protective tube being supported on the stepped portion; and
an anti-detachment ring, an inner circumferential surface of the anti-detachment ring being formed with a second connecting portion, the anti-detachment ring being sleeved on the outer circumferential surface of the acting portion of the socket body, the second connecting portion being in engagement with the first connecting portion, an opposite end of the protective tube abutting the anti-detachment ring.

2. The adapter socket structure according to claim 1, wherein the first connecting portion comprises an annular groove, and the second connecting portion comprises a protruding ring.

3. The adapter socket structure according to claim 2, wherein a first slope is formed on the outer circumferential surface of the acting portion of the socket body between the free end thereof and the first connecting portion; a second slope is formed on the inner circumferential surface of the anti-detachment ring between one end thereof and the protruding ring; and the first slope is in contact engagement with the second slope.

4. The adapter socket structure according to claim 2, wherein the protruding ring comprises a slanted guide surface.

5. The adapter socket structure according to claim 1, wherein the first connecting portion comprises a protruding ring, and the second connecting portion comprises an annular groove.

6. The adapter socket structure according to claim 5, wherein the outer circumferential surface of the acting portion of the socket body is formed with two annular furrows, and the two annular furrows are spaced by a distance so that the protruding ring is formed at a location between the two annular furrows.

7. The adapter socket structure according to claim 5, wherein the anti-detachment ring is formed with a slanted guide surface on the inner circumferential surface between one end thereof and the second connecting portion.

8. The adapter socket structure according to claim 1, wherein an outer circumferential surface of the protective tube is flush with the outer circumferential surface of the driving portion of the socket body, and an outer circumferential surface of the anti-detachment ring is flush with the outer circumferential surface of the protective tube.

9. The adapter socket structure according to claim 1, wherein the protective tube is made of a material of one of carbon fiber and glass fiber.

10. The adapter socket structure according to claim 1, wherein a length of the protective tube is shorter than a length of the acting portion of the socket body.
